(19) United States
(12) Patent Application Publication
(10) Pub. No.: US 2017/0362552 A1
(43) Pub. Date: Dec. 21, 2017

(54) Brewing Process With Electrolytes

(71) Applicant: Zelus Beer Company, LLC, Medfield, MA (US)

(72) Inventors: Geoffrey Pedder, Newton, MA (US); Jonathan Goldstein, Weston, MA (US)

(73) Assignee: Zelus Beer Company, LLC, Medfield, MA (US)

(21) Appl. No.: 15/629,336

(22) Filed: Jun. 21, 2017

Related U.S. Application Data
(60) Provisional application No. 62/352,847, filed on Jun. 21, 2016.

(51) Int. Cl. C12C 12/00; C12C 11/07; C12C 7/20; C12C 11/11; C12C 7/04

(52) U.S. Cl. CPC C12C 12/00; C12C 11/11; C12C 7/042; C12C 7/20; C12C 11/07

(57) ABSTRACT

Methods and processes for brewing malt beverages with electrolytes are provided. In one embodiment of the invention, salts or electrolyte-yielding compounds are added in concentrations or levels greater than those currently believed to be practicable in the art. In some embodiments, the electrolyte-yielding compounds may be added in one or more stages of the brewing process. The methods presented provide flexibility in brewing malt beverages, including beer, with altered electrolyte levels, and alterations of one or more flavors.

### FIELD OF THE INVENTION

The presently disclosed subject matter relates to improved methods of manufacturing malt beverages, including beer, and more specifically, to improved methods and processes for brewing malt beverages, including beer, using electrolyte-yielding compounds or salts in the brewing process to produce malt beverages with altered electrolyte levels, to yield alterations of flavor components, to alter nutrient content, to assist with processing, and to regulate pH during the brewing process.

### BACKGROUND OF THE INVENTION

Brewing of malt beverages, including beer, has been carried out by people for 7,000 years, or more. At its most basic, brewing comprises steeping a source of starch in water to convert long-chain carbohydrates to smaller sugar molecules, and subsequently using yeast to ferment the resulting sweet water. Modern brewing typically comprises four main stages, using a plurality of brewing ingredients: 1) Mashing: grains are mixed with heated water (the “strike water”, meaning the water used as the starting point in the brewing process), to convert starch in the grains to sugars, creating mash: a mix of malty water called wort and residual grain; 2) Sparging: the wort is separated from the grain, and additional water (“sparging water”) is run over or through the residual grain to extract additional sugars from the grains; 3) Boiling: the wort and the sparging water are mixed, and then boiled, and before, during, or after the boiling, the mixed wort and sparging water are combined with hops or hops extracts and possibly other ingredients, creating a hopped wort; and 4) Fermentation: yeast is introduced to the hopped wort at regulated temperatures, and the yeast ferment the sugars in the hopped wort into alcohol and carbon dioxide, creating beer. In most modern brewing processes, a fifth step typically follows fermentation: 5) Carbonation, in which the beverage is carbonated by addition of carbon dioxide gas (CO₂), nitrogen gas (N₂), or a mixture of the two is added to the beer for carbonation or supersaturation with gas so that the beer will have the gas come out of solution, typically creating a foamy head of bubbles, when the beer is depressurized, e.g. when a bottle is opened or beer is poured from a tap. After fermentation and carbonation if used, the beer is typically stored in bottles, cans, or kegs, often at refrigerated temperatures and with little air in contact with the beer.

The fundamental ingredients of a brewed malt beverage, including beer, are water and a source of starch that can be fermented. The source or sources of starch are often referred to, collectively, as the “mash bill” or “grain bill” to be used in any particular brew or brewing process. Typically, a grain is used as the source of starch, most often barley, though other grains including but not limited to wheat, sorghum, rye, rice, corn, millet, or cassava, alone or as an addition to barley. Fermentation of the malt beverage is typically accomplished with a brewer's yeast. The flavoring of the wort is typically done in or around the boiling stage, with hops or other ingredients to create a flavor profile. Collectively, these and similar substances, when used for brewing malt beverages, are referred to herein for simplicity as “brewing ingredients,” which phrase is also to be understood to encompass the products of part of a brewing method, or the final product of a brewing method.

All brewed malt beverages contain electrolytes, which are typically present in some concentrations in all of the ingredients used in the brewing process, including but not limited to the strike water, and any sparging water used, the grain bill, the hops, and other ingredients for flavoring. Brewers may also add salts or other electrolyte-yielding compounds, at one or more stages of the brewing process, to alter the fermentation process; to alter the flavor profile of the beer; to stabilize, regulate, or alter the pH of the mash or other stage of the brewing process; to assist in processing the brew ingredients; to alter the nutrient content of the brew; and/or to augment the conversion of starches to sugars. Electrolytes may also come out of solution during the brewing process, for instance, calcium may precipitate out of solution as calcium oxalate, commonly known as beer stone, or as calcium carbonate, commonly known as chalk. Note, regarding the terms “salts”, “electrolyte-yielding compounds”, and “electrolytes,” that electrolytes are any molecule or substance that, when dissolved in a solvent such as water, creates an electrically conductive solution. An electrolyte, when in solution in a solvent, separates into ions: anions (negatively charged ions) and cations (positively charged ions). The concentration of a particular electrolyte in a solvent, or of all electrolytes collectively, is referred to as the “electrolyte level” or “electrolyte levels.” The ions disperse in the solvent—water, in the case of brewing malt beverages such as beer. A salt is an ionic compound, comprising related numbers of anions and cations. When a salt is dissolved in a solvent, the ions disperse in the solvent, as electrolytes. An electrolyte-yielding compound is any material, including but not limited to salts, that can be dissolved in or added to water, or other solvents, to yield electrolytes. In beer and other brewed malt beverages, some of the more important electrolytes are calcium (Ca⁺²), magnesium (Mg⁺²), bicarbonate (HCO₃⁻¹), potassium (K⁺¹) and sulfate (SO₄⁻²). Sodium (Na⁺¹) and chloride (Cl⁻¹) are also important to the flavor, smell, and appearance of the finished product, but do not as strongly affect the brewing process, such as by altering the pH of the mash, as do calcium, magnesium, bicarbonate, and sulfate.

Altering the base water used in the brewing process has been long known in the art. Brewers may alter the strike water for any of several reasons: to control the pH level of the strike water and of the mash; to control the residual pH (which may also be viewed as the residual alkalinity) of the mash; to ensure that levels of calcium and magnesium are sufficient for flavor and to ensure that the fermenting yeast have sufficient nutrients; to match the electrolyte levels of historic brewing cities; to match the electrolyte levels typical of a particular beer style; to ensure a ratio of chloride to sulfate; for consistency among brewing sessions; or for flavor. Brewers have achieved these objectives by testing their strike water, and then typically using electrolyte-yielding compounds to alter the levels of electrolytes in the strike water, and/or alter the pH of the strike water, soon before combining the strike water and the mash. While electrolyte-yielding compounds may be used by brewers, under the current art, at the sparging and/or boiling stages of the brewing process, brewers typically only add electrolyte-yielding compounds at the start of the brewing process, to the strike water. Electrolyte-yielding compounds that are understood to be used in the art are calcium sulfate (also known as gypsum), calcium chloride, calcium carbonate (also known as chalk), magnesium sulfate (also known as Epsom salt), sodium bicarbonate (also known as baking soda), sodium chloride (also known as table salt, but not enriched with iodine), potassium compounds, and sodium hydroxide. Lactic acid may be used to control pH of the brew process.

Many attempts have been made to create authentic brewed beers with altered flavor profiles. A large variety of beers and brewed malt beverages now exist and are available commercially, e.g. beers flavored with berries, or pumpkin-flavored beers usually made for the fall in the U.S. While many of these are made by a brewing process similar to that described above, many other beer-type beverages or brewed malt beverages are made using processes that deviate from a traditional brewing process. One such beverage is low-alcohol beer, often made in modern brewing techniques by heated distillation of beer with normal alcohol levels to remove alcohol, or more traditionally by reducing the grain bill, i.e. using relatively less grain or other source of starch in the brewing process. Another such brewed malt beverage is a high-alcohol and/or a high-gravity beer (meaning higher concentrations of sugars in the wort, and higher concentrations of sugars and alcohol present in the beer after fermentation), which may be later diluted to create a normal-alcohol or low-alcohol beer. Modern brewers will often add flavor compounds to attempt to adjust for the effect on flavor of the dilution of the high-alcohol and/or high-gravity beer. Yet another brewed malt beverage that deviates from traditional brewing techniques is a beer made with the addition of protein at the end of the typical brewing process.

While some such processes may result in an alcoholic malt beverage with the chemical content of beer, with or without electrolyte levels elevated above typical ranges for traditionally-brewed beer, or with other electrolyte levels altered from typical ranges for traditionally-brewed beer, three problems exist with such products. First, though they may be quite close in chemical content to a traditionally-brewed beer, consumers are accustomed to certain flavor profiles, including but not limited to the look, smell, pH, head, and taste, of brewed beer and beverages. Malt beverages made with processes outside of the traditional brewing path generally do not fit with consumers' expectations, and so the products often do not meet with commercial success. For instance, while high-gravity brewing has become commercially common because it is more cost-efficient, high-gravity beer that is diluted to a more traditional range of alcohol does not necessarily have the flavor profiles that consumers expect, and high-gravity beer that is not diluted may also have different flavor profiles than some consumers expect. Even as consumer tastes change, high-gravity beer, whether diluted or not, may not present a product that is desirable to some or all consumers, whether the high-gravity beer is brewed for purposes including but not limited to flavor alteration, electrolyte alteration, brewing or processing regulation, or other reasons. Second, it is also possible that the marketability and commercial success of high-gravity beer could be improved if it is brewed using regulated and/or altered levels of electrolytes during the brewing process. Third, beverages made with processes that vary too much from a traditional brewing process may not qualify as “beer”, especially in markets and jurisdictions that have defined meanings and requirements for food and beverage labeling. It may be dishonest, or contravene laws or regulations, to market a malt beverage as “beer” if it was not made by a traditional brewing process. A product that imitates beer but is not beer and cannot be marketed as beer may meet with reduced commercial success for reasons of labeling, marketing, and consumer recognition and acceptance. For instance, U.S. Pat. No. 4,073,947 (“Witt”) discloses preparation of a beer-type beverage, but without traditional brewing steps, and includes the addition of certain electrolyte-yielding compounds, including but not limited to potassium phosphate to yield up to 600 ppm potassium in the finished product. Notably, Witt does not disclose brewing beer, but rather producing an alcoholic product similar to beer via a method that is far from traditional brewing.

There also is a market, and a limited set of products, for malt beverages with altered electrolyte levels, whether brewed for flavor alteration, electrolyte alterations, or some combination of the two, that is brewed with an improved brewing process using electrolytes, and not merely malt beverages that have had electrolytes dumped in at or near the end of production, such as in bottling or canning. Many salts and other electrolyte-yielding compounds are commonly found in grains and other flavoring ingredients used for brewing malt beverages. These electrolyte-yielding compounds are often extracted from the grains and flavoring ingredients during the typical brewing process—most commonly, during the mashing and sparging stages. But there is a market demand for malt beverages with electrolyte levels altered from those resulting from the typical brewing process, in which electrolytes are present in and extracted from the ingredients. There is also a market demand for beers with altered flavor profiles, most preferably made through an improved brewing process as opposed to merely having flavoring compounds inserted into the finished products.

Some such drinks are prepared by taking a malt beverage, including but not limited to beer, and adding an after-market powder or tablet containing salts or other electrolyte-yielding compounds. Examples of this include an academic study titled “Beer as a Sport Drink” (Desbrow, 2013) and products made and sold to be added to a beverage by a consumer at the time of consumption. While this would provide a beer with increased electrolyte levels, it gives the producer of any beverage no control over the electrolyte levels or flavor profile of the final product as consumed. This presents at least two problems for most brewers. First, because most brewers, like any chef or other craftsman, take pride in their work, their ingredients, and their finished product, they do not want to sell a product knowing that consumers, or bar and restaurant owners, will be modifying it outside of the control of the producers, possibly for the worse. Second, it means that brewers do not have the opportunity to make, market, and sell products to a potentially valuable niche market: actual brewed beer with altered electrolyte levels and/or altered flavor profiles.

In addition, while there may be known in the art examples of brewing malt beverages, including but not limited to beer, with minor or moderate additions of electrolytes, it has been believed to be unfeasible and/or not commercially viable to brew beer or other malt beverages with multiple electrolytes at concentrations, in the finished product, higher than certain levels widely believed, in the art, to be practicable and acceptable for consumption. For instance, one brewer's reference publication recommends: a maximum calcium concentration of 150 ppm; a maximum magnesium concentration of 30 ppm; a maximum bicarbonate concentration of 250 ppm; a maximum sulfate concentration of 150 ppm for normally bitter beers and 350 ppm for very bitter beers; a maximum sodium concentration of 150 ppm; and a maximum chloride concentration of 250 ppm. Palmer's book states, as the current understanding of the art, that higher concentrations of various of those electrolytes may lead to a sour or bitter taste (for magnesium over 50 ppm), a laxative or diuretic effect (for magnesium over 125 ppm), an astringent bitterness (for sulfate over 400 ppm) or diarrhea (for sulfate over 750 ppm), a salty taste (for sodium over 200 ppm), a harsh bitterness (for sodium with high sulfate concentrations), and mediciney flavors (for chloride over 300 ppm) (“How to Brew”, John Palmer, Brewers Publications, 2006; see also Charles W. Bamforth, “Beer: Health and Nutrition”, Wiley-Blackwell, 2004, p. 110). Furthermore, it has been believed in the art to be unfeasible to add any or all of the salts or electrolyte-yielding compounds at any stage or all stages of the brewing process—the prevailing understanding among brewers and those skilled in the art is that certain electrolyte-yielding compounds can be added only at certain stages of the brewing process, such as to the strike water before mashing with some or all of the grain bill, during the sparging, or during the boiling (see, for instance, John Palmer and Colin Kaminski, “Water: A Comprehensive Guide for Brewers”, at pp. 101-137 on ‘Controlling Alkalinity’ and at pp. 139-178 on ‘Adjusting Water For Style’, 2013). Refer to FIG. 3A for a summary of the understanding, in the current art, of which electrolyte-yielding compounds may be added at which stages of the brewing process; and see FIG. 3B for a summary of the understanding, in the current art, of upper limits for electrolyte levels in the strike or sparging water, and of upper limits for electrolyte levels in the final product. These constraints on the current art of the brewing process have limited the flexibility of brewers in creating brewed malt beverages, including but not limited to beer, that is higher in electrolytes than typical beer while retaining the flavor profiles, look, smell, and/or organoleptic qualities of typical beer varieties.

### SUMMARY OF THE INVENTION

The present invention meets all these needs, by disclosing methods and processes for brewing beer or any malt beverage that follow traditional brewing practices, with the addition of salts or other compounds that create electrolytes in the finished product, at one or more of the stages of traditional brewing practices. At a high level of summary, in the presently disclosed methods, the salts or other compounds that create electrolytes in the finished product are added in the brewing process at concentrations above those currently recognized in the art of brewing as acceptable, yielding unexpected results. The inventive methods result in a traditional product, with a look, smell, and taste of traditional brewed beer and malt beverages, but with altered electrolyte levels and/or an altered flavor profile. An object of the invention is to provide a traditionally-brewed beer with altered electrolyte levels, resulting in a beer or other malt beverage that is recognized and accepted by consumers as a beer (or other malt beverage), and which can be marketed as a traditional brewed beer (or other malt beverage). Another object of the invention is to provide a traditionally-brewed beer with altered flavor profiles. Other objectives of the present invention are to provide a method for brewing with electrolyte-yielding compounds for increased pH regulation during the brewing process, and/or for use as processing aids during the brewing process.

A further object of the present invention is to provide brewers with methods to control the electrolyte levels in malt beverages, including beer, by disclosing methods for brewing with one or more additions of salts or electrolytes at concentrations higher than is presently known in the art, or otherwise altered. Accordingly, brewers will be able to make and market an actual brewed beer with altered electrolyte levels and a flavor profile, look, and smell that the brewers have been able to test and control, and with the flavor profile optionally altered based at least in part on the electrolyte-yielding compounds. Additionally, the present invention discloses additions of the salts or electrolyte-yielding compounds at any stage of the brewing process, in contrast with the current state of the art, creating a beer or malt beverage through the traditional brewing process with control by the brewer of the altered electrolyte levels and/or altered flavor profile. The present invention also discloses malt beverages, including but not limited to beer, made with any of the presently disclosed methods.

As a mid-level overview of the present invention, the presently disclosed methods comprise additions of one or more salts, or other electrolyte-yielding compounds, to the brewing ingredients or steps, before, during or after one or more of the steps of the brewing process. The present invention provides improvements in flexibility of the brew process. The present invention also provides improvements in which types of beers may be produced in a given location with a particular water supply, because the water available as an ingredient for making the malt beverage strongly influences the range of finished products (specifically, their flavor profiles, looks, and smells) that can be produced in a location. By providing methods for producing beers and other malt beverages with electrolyte additions in production that exceed what is currently believed to be feasible in the art of brewing, the present invention expands the types and flavors of malt beverages that can be brewed at a given location. Any such applications of the present invention provide improved convenience, control, and flexibility over the present art.

The present invention provides methods for controlling the levels of electrolytes that the current art of brewing does not consider important: sodium and potassium. The present invention provides methods for controlling the levels of electrolytes, principally sodium, potassium, magnesium, and calcium, and others, throughout the brewing process, meaning at any stage of brewing, and not only to the strike water, during the sparging, or during the boiling stage. The present invention presents methods to alter the levels of one or more electrolytes to be different from typical levels of electrolytes found in beer. In some embodiments of the present invention, levels of one or more electrolytes are altered to be higher than in typical beer brewing processes. The present invention also uses electrolyte-yielding compounds that are not typically used, or not used at all, in the current art of brewing.

Lastly, the present invention provides improvement over the current state of the art of brewing malt beverages or beer, by simplifying the production of beer with altered electrolyte levels and/or altered flavor profiles.

These aspects of the present invention, and other disclosed in the Detailed Description of the Drawings, represent improvements on the current art. This summary is provided to introduce a selection of concepts in a simplified form that are further described below in the Detailed Description of the Drawings. This Summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; but, the presently disclosed subject matter is not limited to the specific methods and instrumentalities disclosed. In the drawings, like reference characters generally refer to the same components or steps of the device throughout the different figures. In the following detailed description, various embodiments of the present invention are described with reference to the following drawings, in which:

FIG. 1 shows a view of an exemplary embodiment of brewing equipment and brewing ingredients such as may be used to carry out the present invention.

FIG. 2 depicts electrolyte levels in parts per million (ppm) of the water supplies of well-known brewing cities, and types of beer typically made in those cities with water supplies at approximately those electrolyte levels.

FIG. 3A summarizes, in tabular form, the understanding in the current art of which electrolyte-yielding compounds may be added at certain stages of the brewing process.

FIG. 3B summarizes, in tabular form, the understanding in the current art of upper limits for electrolyte levels in the strike or sparging water, and of upper limits for electrolyte levels in the final product; where values are not specified there is no generally known limit.

FIG. 4 depicts an exemplary method of brewing beer or other malt beverages, and ingredients which may be used in the exemplary method.

### DETAILED DESCRIPTION OF THE DRAWINGS

The presently disclosed invention is described with specificity to meet statutory requirements. But, the description itself is not intended to limit the scope of this patent. Rather, the claimed invention might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

The present subject matter discloses methods and processes for brewing malt beverages, including but not limited to beer. As a mid-level overview, the present invention presents modifications to traditional methods of brewing malt beverages, the modifications comprising altering the electrolyte levels in, and/or altering the flavor profiles of, the finished products by the addition of one or more electrolyte-yielding compounds to the ingredients of the brewed malt beverage, at, before, or after one or more of the steps of the traditional brewing process. In addition to the goals of altering electrolyte levels in the finished product, and or altering the flavor profiles of the finished product, any or all of the presently-disclosed additions of electrolyte-yielding compounds, at any stage of the brewing process, may be used and intended for use to regulate pH at a plurality of stages of the brewing process; to serve as a processing aid at a plurality of stages of the brewing process; to serve as a flavor enhancer or to alter the flavor of the finished product; to serve as a flavor aid; and/or to serve as a nutrient enhancer or to alter the nutrient content of the finished product, any of which are in accordance with CFR 21 Part 184.

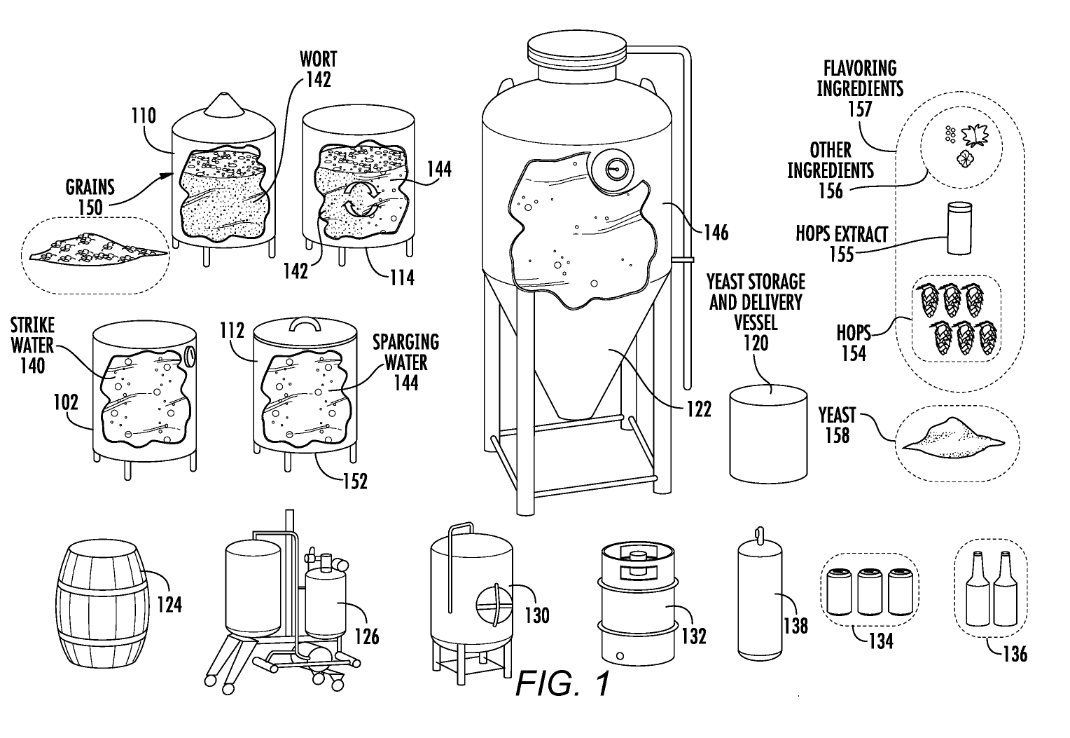

FIG. 1 presents representative equipment and ingredients that may be used in brewing malt beverages following the methods disclosed herein. While exemplary equipment is listed here, this listing is not intended to exclude other equipment that may be used, in addition to or in place of various of the exemplary equipment listed herein, in carrying out any of the presently disclosed methods. Such exemplary equipment may include, but is not limited to, a hot water tank 102 which may be used for brew water treatment, a mash conversion vessel 110, a lauter tun 112, a brew kettle 114 (also known in the art as a boil kettle), a yeast storage and delivery vessel 120, a fermentation vessel 122, a barrel 124, a filtration system 126, a bright tank 130, a keg 132, cans 134, bottles 136, and a CO₂ storage tank 138. With any of the foregoing list of equipment and ingredients, each or any of the items may be a plurality of items, as multiple of any of the items listed here (or other items of equipment not listed) may be used in carrying out any of the methods presently disclosed. Note, also, that as the brewing process necessarily converts a plurality of ingredients into another ingredient or plurality of ingredients, various of the ingredients listed are to be understood as being the current incarnation of another ingredient or plurality of ingredients at a plurality of stages of the brewing process, and not as separate and wholly distinct ingredients that are created or added at different steps of the brewing process. For instance, the water comprising the strike water 140 is later, after alteration and addition of one or more various ingredients, water referred to as the wort 142. Note also that while various of the ingredients are depicted in FIG. 1 as being present in or introduced into various of the equipment, this is only for illustrative purposes, and is not intended to limit in which items of equipment any of the ingredients may or may not be introduced or placed.

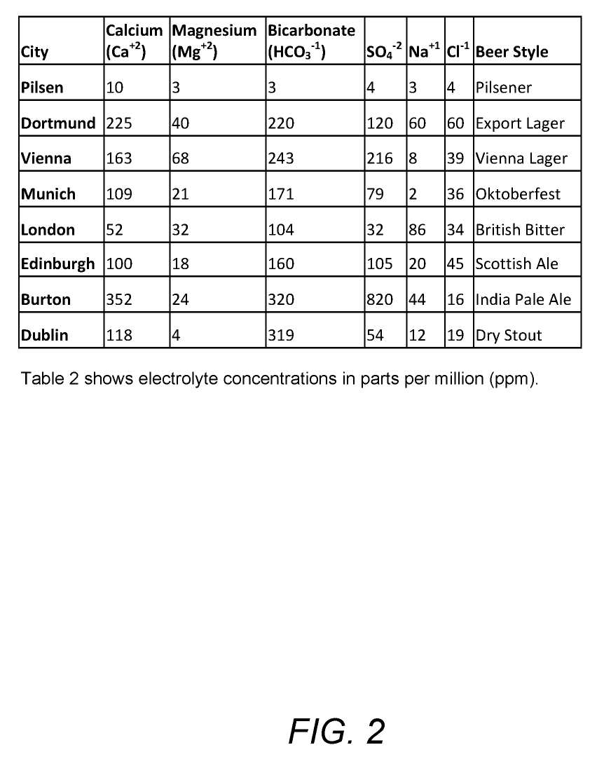

With reference to FIG. 2, it is apparent, and well known to one of skill in the art, that the electrolyte levels of the strike water 140 used in brewing vary widely. FIG. 2 depicts typical electrolyte levels in parts per million (ppm) of the water supplies of well-known brewing cities, and types of beer typically made in those cities with water supplies at approximately those electrolyte levels. The electrolytic composition of the water used influences the resulting chemical composition of the beer that is produced, leading in part to the regional differences in beer flavor, color, smell, pH, and head (the foam of bubbles at the top of a poured or drawn beer) that are well known to those skilled as brewers, to merchants, and to most knowledgeable consumers of beer and other malt beverages. While other factors affect the finished product, such as the type of grain 150, how it is treated, other ingredients used, the yeast 158 used, and the temperature and time used in various of the steps of the brewing process, it is well established that the electrolyte composition of the strike water 140 strongly influences the beer that is produced. FIG. 2 also depicts the typical beer style brewed in various regions, with those traditional beer styles influenced by the locally available ingredients, and by the water used in the brewing process as an ingredient—the strike water 140.

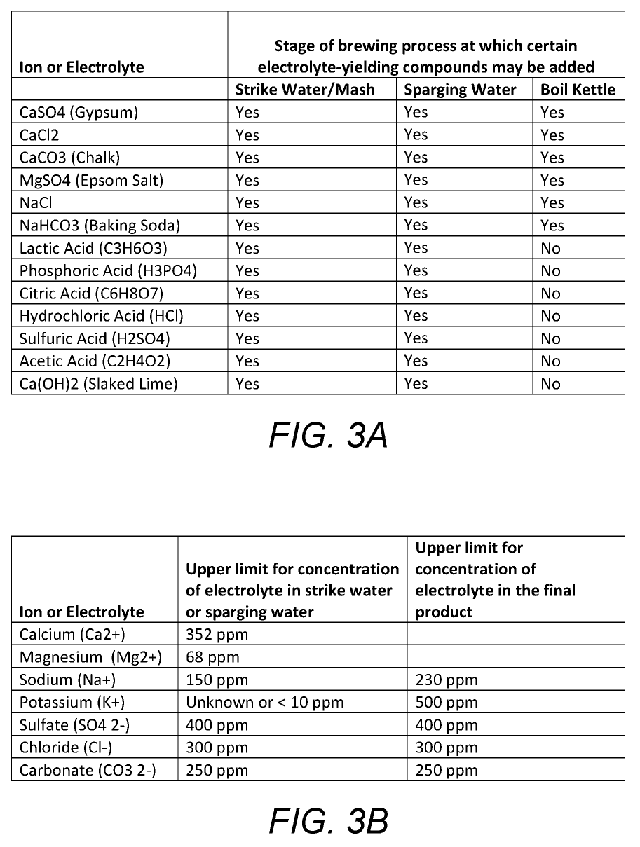

FIG. 3A illustrates the state of the current art with regard to which electrolyte-yielding compounds are recommended to be added at which stages of the brewing process. With reference to FIG. 3B, well-known guides to brewing make recommendations for upper limits of electrolyte levels, for various electrolytes, to be used in the strike water 140 and/or sparging water 144 to brew different varieties of beer; where values are not specified there is no generally known or recommended limit. These electrolyte levels will vary with the style of beer which the brewer intends to brew. Traditionally, styles of beer developed in different places, and the various styles of beer were and are strongly determined by the naturally-occurring electrolyte levels in the local water supply. Depending on the local water supply, whether tap or bottled, a brewer may be able to brew some or all of the traditional types of beer, based in large part on the electrolyte content of the available water (assuming, of course, that other ingredients required for any particular style of beer are available or can be purchased). The recommendations in FIG. 3B illustrate the state of the known prior art with regard to recommendations for electrolyte levels in the strike water 140, and for levels of electrolytes in the finished brewed product. The present invention discloses levels of electrolytes in the strike water 140 and/or as additions at one or more later steps of the brewing process, yielding electrolyte levels in the finished brewed malt beverage that exceed the currently known viable maximum levels for electrolyte concentrations in the strike water 140. It is presently believed that brewing beer with electrolyte levels exceeding those maximum recommendations will result in failed brews. The present invention presents methods for brewing with electrolytes at levels exceeding the currently understood state of the art, for pH regulation, and/or as a processing aid, and/or otherwise altering the electrolyte levels in the finished brewed product, and/or altering the flavor profiles of the finished brewed product.

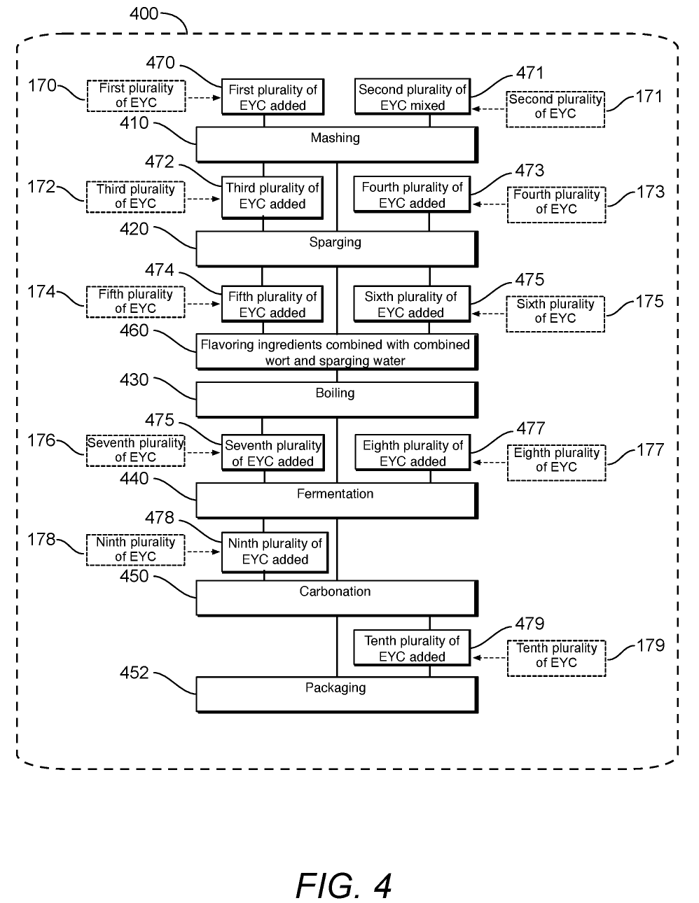

With reference to FIG. 4, an exemplary method 400 of brewing malt beverages is presented. The traditional brewing process comprises the steps of mashing 410, sparging 420, boiling 430, fermentation 440, and then typically carbonation 450, followed by packaging 452 (and sometimes, a carbonation 450 is added in the packaging 452). In some embodiments of the present invention, a first plurality of electrolyte-yielding compounds 170 may be added 470 to the strike water 140 before or after the grains 150 are mixed with the strike water 140. In other embodiments of the invention, a second plurality of electrolyte-yielding compounds 171 may be mixed 471 with the grains 150 or processed with the grains 150 prior to mixing the strike water 140 and the grains 150.

In still other embodiments, a third plurality of electrolyte-yielding compounds 172 may be added 472 to the wort 142 after the wort 142 is separated from the residual grain 152. A fourth plurality of electrolyte-yielding compounds 173 may be added 473 to the sparging water 144 before, while, or after the sparging water 144 is run over or through the residual grain 152. A fifth plurality of electrolyte-yielding compounds 174 may be added 474 to the combined wort 142 and sparging water 144 after the wort 142 and sparging water 144 are combined but before the hops 154, hops extracts 155, and/or other ingredients 156 (collectively, the flavoring ingredients 157) are combined 460 with the combined wort 142 and sparging water 144, creating a hopped wort 142. In some embodiments of the present invention, a sixth plurality of electrolyte-yielding compounds 175 may be added 475 to the wort 142 and sparging water 144 while the combining 460 of the flavoring ingredients 157 with the mixed wort 142 and sparging water 144 is occurring, or after the combining 460 of the flavoring ingredients 157 with the mixed wort 142 and sparging water 144 has occurred, created the hopped wort 142. The additions of the fifth plurality of electrolyte-yielding compounds 174 and of the sixth plurality of electrolyte-yielding compounds 175 may take place before the mixed wort 142 and sparging water 144 are boiled, while the mixed wort 142 and sparging water 144 are being boiled, or after the mixed wort 142 and sparging water 144 have been boiled.

In some embodiments, a seventh plurality of electrolyte-yielding compounds 176 may be added 476 to the hopped wort 142 before the introduction of the yeast 158. In other embodiments of the invention, an eighth plurality of electrolyte-yielding compounds 177 may be added 477 to the hopped wort 142 after the yeast 158 have been introduced and begun fermenting 440 the hopped wort 142 into beer or another malt beverage 146. A ninth plurality of electrolyte-yielding compounds 178 may be added 478 to the malt beverage 146 after fermentation 440 is complete and before carbonation 450. In other embodiments, a tenth plurality of electrolyte-yielding compounds 179 may be added 479 to the malt beverage 146 after carbonation 450, before or up to the time when the malt beverage 146 is packaged 452.

In any embodiments of the present invention, the first plurality of electrolyte-yielding compounds 170, second plurality of electrolyte-yielding compounds 171, third plurality of electrolyte-yielding compounds 172, fourth plurality of electrolyte-yielding compounds 173, fifth plurality of electrolyte-yielding compounds 174, sixth plurality of electrolyte-yielding compounds 175, seventh plurality of electrolyte-yielding compounds 176, eighth plurality of electrolyte-yielding compounds 177, ninth plurality of electrolyte-yielding compounds 178, and tenth plurality of electrolyte-yielding compounds 179 may be identical to each other in composition and relative amounts of electrolyte-yielding compounds, or may all be different, or some of the pluralities of electrolyte-yielding compounds may be different and some the same. Each of the pluralities of electrolyte-yielding compounds may comprise one or more compounds, to yield one or more different electrolytes upon addition to the malt beverage or ingredients during the brewing process as described above, and in any of a range of concentrations that may vary for each electrolyte independently, such that, at, before, or after each step of the brewing process, any of the plurality of electrolytes may be within ranges heretofore understood in the art to be acceptable at that step of the brewing process, and any of the plurality of electrolytes may be altered to be outside of ranges heretofore understood in the art to be acceptable at that step of the brewing process.

The following electrolyte-yielding compounds may be used in the foregoing description of the present invention. Any of these electrolyte-yielding compounds may be used as a pure or nearly pure reagent, provided they are physically or chemically safe to add to water (e.g. pure sodium or potassium should not be used, as they would explode), or mixed with any other compounds, either as stabilizers, dispersants, or other electrolyte-yielding compounds. This listing is not meant to be exhaustive or limiting, but rather to illustrate the range of salts and other electrolyte-yielding compounds that may be used in the inventive method for pH regulation and/or as a processing aid during brewing, and/or to create altered electrolyte levels and/or altered flavor profiles in the brewed malt beverage, which electrolytes may include but are not limited to ionic forms of calcium, magnesium, potassium, sodium, chlorine (such as chloride), sulfur (such as sulfate or sulfite), carbon (such as carbonate or bicarbonate), citrate, and hydroxide.

To yield calcium ions as an electrolyte, electrolyte-yielding compounds that may be used include, but are not limited to, calcium chloride, calcium sulfate (commonly referred to as gypsum), calcium gluconate, calcium citrate, calcium hydroxide, calcium phosphate, calcium carbonate (commonly referred to as chalk), calcium acetate, calcium alginate, calcium glycerophosphate, calcium iodate, calcium lactate, calcium oxide, calcium pantothenate, calcium propionate, and calcium stearate. To yield potassium ions as an electrolyte, electrolyte-yielding compounds that may be used include, but are not limited to, potassium chloride, potassium sulfate, potassium gluconate, potassium citrate, potassium hydroxide, potassium phosphate, potassium bicarbonate, potassium alginate, potassium carbonate, potassium citrate, potassium hydroxide, potassium iodide, potassium iodate, and potassium lactate. To yield further alterations in the levels of potassium as an electrolyte, electrolyte-yielding compounds that may be used include, but are not limited to, chloride salts and/or sulfate salts.

To yield magnesium ions as an electrolyte, electrolyte-yielding compounds that may be used include, but are not limited to, magnesium sulfate, magnesium bicarbonate, magnesium citrate, magnesium carbonate, magnesium chloride, magnesium hydroxide, magnesium oxide, magnesium phosphate, and magnesium stearate. To yield sodium ions as an electrolyte, electrolyte-yielding compounds that may be used include, but are not limited to, sodium chloride (commonly referred to as table salt, and used as a flavoring in beer and malt beverages, in addition to being used as an electrolyte-yielding compound for brewing), sodium sulfate, sodium gluconate, sodium citrate, sodium hydroxide, sodium phosphate, sodium bicarbonate, sodium acetate, sodium alginate, sodium benzoate, sodium carbonate, sodium diacetate, sodium hypophosphite, sodium lactate, sodium metasilicate, sodium propionate, sodium sesquicarbonate, sodium tartrate, sodium potassium tartrate, and sodium thiosulfate.

The electrolyte concentrations in the finished brewed malt beverage or in the stages of the production of the malt beverage during the carrying out of the present invention may exceed the following levels. The concentration of calcium ions in a brewed malt beverage, or in any liquid ingredient used or present in any step of the presently disclosed invention including but not limited to the strike water 140 and/or the sparging water 144, may exceed approximately 352 parts per million (ppm) under the presently disclosed invention. The concentration of calcium may be altered to achieve any such concentration in any such ingredient. As used throughout the discussion of the present invention, “altered” means changed by the brewer or practitioner of the present invention, by use of addition or removal of any ingredient or substance. 352 ppm of calcium is the historic water profile for Burton on Trent, England, and this concentration of calcium is the highest recommended in the current art for brewing beer or other malt beverages.

The concentration of magnesium ions in a brewed malt beverage, or in any liquid ingredient used or present in any step of the presently disclosed invention including but not limited to the strike water 140 and/or the sparging water 144, may exceed approximately 68 ppm under the presently disclosed invention. The concentration of magnesium may be altered to achieve any such concentration in any such ingredient. 68 ppm of magnesium is the historic water profile for Vienna, Austria, and this concentration of magnesium is the highest recommended in the current art for brewing beer or other malt beverages.

The concentration of sodium ions in a brewed malt beverage, or in any liquid ingredient used or present in any step of the presently disclosed invention including but not limited to the strike water 140 and/or the sparging water 144, may exceed approximately 230 ppm under the presently disclosed invention. The concentration of sodium may be altered to achieve any such concentration in any such ingredient. 86 ppm of sodium is the historic water profile for London, England. 230 ppm of sodium is the highest recommended concentration in the current art for brewing beer or other malt beverages.

The concentration of potassium ions in a brewed malt beverage, or in any liquid ingredient used or present in any step of the presently disclosed invention including but not limited to the strike water 140 and/or the sparging water 144, may exceed approximately 500 ppm under the presently disclosed invention. In some embodiments of the present invention, the concentration of potassium may exceed approximately 1100 ppm in a brewed malt beverage, or in any liquid ingredient used or present in any step of the presently disclosed invention including but not limited to the strike water 140 and/or the sparging water 144. The concentration of potassium may be altered to achieve any such concentration in any such ingredient. In some embodiments of the present invention, the concentration of potassium in the strike water 140 and/or in the sparging water 144 may be altered by more than approximately 50 ppm, not counting any alteration of the potassium concentration in the strike water 140 due to the addition of or mixing of the grains 150 with the strike water 140, and subsequent mashing 410. Potassium is typically, under the present art, not added as an electrolyte because potassium occurs naturally in the grains 150 that are used for brewing, and potassium is extracted from those grains 150 during the mashing 410. The currently accepted range of potassium concentrations in brewed malt beverages is approximately 300 to 500 ppm, and though there are examples of beer-type beverages with potassium concentrations of up to 600 ppm potassium, such as that disclosed by Witt, 500 ppm of potassium is the highest recommended in the current art for brewing beer or other malt beverages.

Any of the foregoing additions of electrolyte-yielding compounds may be used: to regulate pH during the brewing process, at any stage of the brewing process; to serve as a processing aid, at any stage of the brewing process; and/or to assist with other alterations to the brewing process.

Certain embodiments of the present invention were described above, to provide methods for brewing beer or other malt beverages with altered electrolyte levels and/or altered flavor profiles. From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. It is expressly noted that the present invention is not limited to those embodiments described above, but rather the intention is that additions and modifications to what was expressly described herein are also included within the scope of the invention. Moreover, it is to be understood that the features of the various embodiments described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

Accordingly, what is claimed is:

1. A method for brewing malt beverages using one or more pluralities of brewing ingredients and one or more pluralities of electrolyte-yielding compounds, the method comprising:
mashing of a first plurality of the brewing ingredients, comprising strike water and grains, creating a plurality of mash comprising a plurality of wort and a plurality of residual grain; then
sparging the plurality of residual grain with a second plurality of the brewing ingredients, creating a plurality of sparging water; then
boiling the plurality of wort and the plurality of sparging water with a third plurality of the brewing ingredients, creating a plurality of altered wort; and then
fermentation of the plurality of altered wort with a fourth plurality of brewing ingredients, resulting in a plurality of brewed malt beverage.

2. The method of claim 1, in which after fermentation of the plurality of altered wort, the plurality of brewed malt beverage is carbonated.

3. The method of claim 1, in which a first plurality of electrolyte-yielding compounds is mixed with the strike water before the grains are mixed with the strike water.

4. The method of claim 1, in which a first plurality of electrolyte-yielding compounds is mixed with the strike water after the grains are mixed with the strike water.

5. The method of claim 1, in which a second plurality of electrolyte-yielding compounds is mixed with the grains prior to mixing the strike water and the grains.

6. The method of claim 1, in which the plurality of wort and the plurality of residual grain are separated, and then a third plurality of electrolyte-yielding compounds is added to the plurality of wort.

7. The method of claim 1, in which a fourth plurality of electrolyte-yielding compounds is added to the plurality of sparging water before, while, or after the plurality of sparging water is run over or through the plurality of residual grain.

8. The method of claim 1, in which the plurality of wort and the plurality of sparging water are combined, and in which a fifth plurality of electrolyte-yielding compounds is added to the combined wort and sparging water after the plurality of wort and the plurality of sparging water are combined, the addition of the fifth plurality of electrolyte-yielding compounds occurring before the third plurality of the brewing ingredients, which further comprises a plurality of flavoring ingredients, is combined with the combined wort and sparging water.

9. The method of claim 1, in which the plurality of wort and the plurality of sparging water are combined, and in which a sixth plurality of electrolyte-yielding compounds is added to the combined wort and sparging water after the plurality of wort and the plurality of sparging water are combined, the addition of the sixth plurality of electrolyte-yielding compounds occurring while or after the third plurality of the brewing ingredients, which further comprises a plurality of flavoring ingredients, is combined with the combined wort and sparging water.

10. The method of claim 1, in which a seventh plurality of electrolyte-yielding compounds is added to the plurality of altered wort before the fourth plurality of brewing ingredients, which fourth plurality of brewing ingredients comprises yeast.

11. The method of claim 1, in which an eighth plurality of electrolyte-yielding compounds is added to the plurality of altered wort after the fourth plurality of brewing ingredients, which fourth plurality of brewing ingredients comprises yeast.

12. The method of claim 1, in which a ninth plurality of electrolyte-yielding compounds is added to the plurality of brewed malt beverage after fermentation.

13. The method of claim 2, in which a tenth plurality of electrolyte-yielding compounds is added to the plurality of brewed malt beverage after the plurality of brewed malt beverage is carbonated.

14. The method of claim 1, in which one or more of the pluralities of electrolyte-yielding compounds yield potassium ions as an electrolyte.

15. The method of claim 1, in which one or more of the pluralities of electrolyte-yielding compounds yield sodium ions as an electrolyte.

16. The method of claim 1, in which one or more of the pluralities of electrolyte-yielding compounds yield citrate ions as an electrolyte.

17. The method of claim 1, in which the concentration of calcium ions may exceed approximately 352 parts per million in the strike water and/or in the sparging water and/or in the plurality of brewed malt beverage.

18. The method of claim 17, in which the concentration of calcium ions is altered to exceed approximately 352 parts per million.

19. The method of claim 1, in which the concentration of magnesium ions may exceed approximately 68 parts per million in the strike water and/or in the sparging water and/or in the plurality of brewed malt beverage.

20. The method of claim 19, in which the concentration of magnesium ions is altered to exceed approximately 68 parts per million.

21. The method of claim 1, in which the concentration of sodium ions may exceed approximately 230 parts per million in the strike water and/or in the sparging water and/or in the plurality of brewed malt beverage.

22. The method of claim 21, in which the concentration of sodium ions is altered to exceed approximately 230 parts per million.

23. The method of claim 1, in which the concentration of potassium ions may exceed approximately 500 parts per million in the strike water and/or in the sparging water and/or in the plurality of brewed malt beverage.

24. The method of claim 23, in which the concentration of potassium ions is altered to exceed approximately 500 parts per million.

25. The method of claim 1, in which the concentration of potassium ions in the strike water and/or in the sparging water is altered by more than approximately 50 ppm.

26. The method of claim 1, in which the concentration of potassium ions may exceed approximately 1100 parts per million in the plurality of brewed malt beverage.

27. A method for regulating pH during the brewing process when brewing a malt beverage; in which said brewing process comprises mashing brewing ingredients creating wort and residual grain, sparging the residual grain creating sparging water, boiling the wort and sparging water creating altered wort, and fermenting the altered wort created a brewed malt beverage; the method comprising adding one or more pluralities of electrolyte-yielding compounds to regulate the pH of one or more of the brewing ingredients, the wort, the residual grain, the sparging water, the altered wort, and the brewed malt beverage.

28. The method of claim 27, in which one or more of the pluralities of electrolyte-yielding compounds yield, as electrolytes, one or more of calcium ions, magnesium ions, potassium ions, sodium ions, chloride ions, sulfate ions, carbonate or bicarbonate ions, citrate ions, or hydroxide ions.

29. A method for using one or more pluralities of electrolyte-yielding compounds to aid in the processing of brewing ingredients during one or more steps of the brewing process when brewing a malt beverage; in which said brewing process comprises the steps of mashing brewing ingredients creating wort and residual grain, sparging the residual grain creating sparging water, boiling the wort and sparging water creating altered wort, and fermenting the altered wort created a brewed malt beverage.

30. The method of claim 29, in which one or more of the pluralities of electrolyte-yielding compounds yield, as electrolytes, one or more of calcium ions, magnesium ions, potassium ions, sodium ions, chloride ions, sulfate ions, carbonate or bicarbonate ions, citrate ions, or hydroxide ions.
